(19) United States
(12) Patent Application Publication
(10) Pub. No.: US 2019/0289300 A1
(43) Pub. Date: Sep. 19, 2019

(54) IMAGE COMPRESSION SYSTEM AND IMAGE COMPRESSION METHOD USING IMAGE COMPRESSION SYSTEM

(71) Applicant: MStar Semiconductor, Inc., Hsinchu Hsien (TW)

(72) Inventors: Yi-Chin HUANG, Hsinchu Hsien (TW); Yi-Shin TUNG, Hsinchu Hsien (TW)

(21) Appl. No.: 16/141,185

(22) Filed: Sep. 25, 2018

(30) Foreign Application Priority Data
Mar. 16, 2018 (TW) 107108957

(51) Int. Cl. H04N 19/172; H04N 19/176; H04N 19/152

(52) U.S. Cl. CPC H04N 19/172; H04N 19/152; H04N 19/176

(57) ABSTRACT

A method for compressing an image frame. Display data of a plurality of image blocks in the image frame is transmitted in a raster san order to a post-processing circuit. Upon receiving the display data of one image block, the post-processing circuit reads intermediate data of a buffering image block corresponding to the image block from a buffer memory, performs post-processing on the intermediate data of the buffering image block and display data of a main sub-block in the image block according to the display data of the image block and the intermediate data of the buffering image block to generate post-processed data of a post-processed image block, and stores the intermediate data of an intermediate image block in the image block to the buffer memory. A compressor compresses the post-processed data of the post-processed image block into compression data of the post-processed image block.

This application claims the benefit of Taiwan application Serial No. 107108957, filed Mar. 16, 2018, the subject matter of which is incorporated herein by reference.

### BACKGROUND OF THE INVENTION

### Field of the Invention

The invention relates to an image compression system and more particularly, to an image compression system capable of reducing the size of a buffer memory.

### Description of the Related Art

In the prior art, in order to reduce memory space and bandwidth needed for storing images, an image can be compressed through various different types of image coding algorithms. Among many common coding algorithms, such as the video coding standard H.264, High Efficiency Video Coding (HEVC) and the VP8 video compression format proposed by Google, an image frame to be compressed is first divided into a plurality of image blocks, and each of the image blocks is then compressed. During a decompression process, the image blocks are also individually decompressed. After decompressing and restoring the image blocks and before storing them to an external memory, some conventional solutions compress the image blocks before storing them to the external memory so as to reduce the bandwidth needed between a decompression chip and the external memory.

FIG. 1 shows a schematic diagram of an image frame IMG0 that is to be compressed before storing the image frame IMG0 in the prior art. In FIG. 1, the image frame IMG0 includes a plurality of image blocks BLK(1, 1) to BLK(X, Y), where X and Y are positive integers greater than 1. In a coding algorithm of the prior art, the plurality of image blocks BLK(1,1) to BLK(X, Y) of the image frame IMG0 are compressed in a raster scan order. That is to say, a coding algorithm of the prior art first sequentially compresses the first-row image blocks BLK(1, 1), BLK(1, 2) to BLK(1, Y), and sequentially compresses the second-row image blocks BLK(2, 1), BLK(2, 2) to BLK(2, Y), and so forth.

Further, to prevent causing defects on borders of each of the image blocks, post-processing is performed on each of the image blocks before the image blocks are compressed. In post-processing, computation is frequently performed according to display data of each image block and adjacent image blocks thereof. For example, for the above video coding standard H.264, HEVC and VP8 video compression format, post-processing includes a step of deblocking filtering in a post-processing procedure.

When performing post-processing on the image block BLK(2, 1) in FIG. 1, post-processing on only a sub-block A(2, 1) in the image block BLK(2, 1) can be completed without having to refer to display data of other image blocks. However, to perform post-processing on a sub-block S(2, 1) in the image block BLK(2, 1), in addition to display data of the image block BLK(2, 1), display data of a sub-block S′(2, 2) in the image block BLK(2, 2) located on the right of the image block BLK(2, 1) is also needed in order to perform the step of deblocking filtering. Similarly, to perform post-processing on a sub-block C(2, 1) in the image block BLK(2, 1), in addition to display data of the image block BLK(2, 1), display data of a sub-block C′(3, 1) in the image block BLK(3, 1) located below the image block BLK(2, 1) is also needed in order to perform the step of deblocking filtering.

According to a raster scan order, display data of the image block BLK(3, 1) is received only after display data of the image blocks BLK(2, 2) to the image block BLK(2, Y) is sequentially received. Thus, to complete post-processing required in a coding algorithm, in a conventional image compression process, display data of the image block BLK(2, 1) is temporarily stored in a buffer memory, and post-processing can be completed only after image data of the image block BLK(3, 1) is received. Otherwise, if the image block BLK(2, 1) is compressed and stored to an external memory, instead of separately reading display data of the sub-block C(2, 1) in the image block BLK(2, 1) as desired, the entire image block BLK(2, 1) needs to be read, restored and then re-written. Furthermore, for the re-writing process, because the memory space needed may increase or decrease compared to the originally used memory space, remaining data needs to be written to another memory or to another available space not used in the original memory, hence resulting a waste in the external memory.

Similarly, to complete post-processing of the image block BLK(2, 2), display data of the image block BLK(2, 2) is first temporarily stored in a buffer memory, and post-processing can then be completed after image data of the image block BLK(3, 2) is received.

As such, although the prior art can complete post-processing, a large-capacity buffer memory is needed for storing display data of image blocks, e.g., display data of an entire row of image blocks. Further, although post-processing on display data of some sub-blocks in each image block can be in fact accomplished without referring to display data of other image blocks, the prior art nonetheless stores display data of an entire image block to the memory. For an image compression system, such large memory results in additional hardware burden and at the same time increases overall system power consumption and bandwidth required. Therefore, there is a need for a solution for effective image compression.

### SUMMARY OF THE INVENTION

According to an embodiment of the present invention, a method for compressing an image frame by using an image compression system is provided. The image compression system includes a post-processing circuit, a compressor and a buffer memory. The method includes transmitting display data of a plurality of image blocks in the image frame in a raster scan order to the post-processing circuit. Each of the image blocks includes N rows of pixels, where N is a positive integer greater than 1.

When the post-processing circuit receives the display data of a first image block, and the first image block is an image block located at neither the first row in the image frame nor the last row in the image frame, the post-processing circuit reads data to be processed (to be referred to as intermediate data) of a first buffering image block corresponding to the first image block from the buffer memory, performs post-processing of a coding algorithm on the intermediate data of the first buffering image block and the display data of a first main sub-block in the first image block according to at least the display data of the first image block and the intermediate data of the first buffering image block to generate post-processed data of a first post-processed image block, and stores the intermediate data of a first sub-block to be processed (to be referred to as a first intermediate sub-block) in the first image block that does not belong to the first main sub-block to the buffer memory. The compressor compresses the post-processed data of the first post-processed image block into compression data of the first post-processed image block.

The first intermediate sub-block is the last n rows of pixels in the first image block, and the first main sub-block is first (N−n) rows of pixels in the first image block, where n is a positive integer smaller than N.

According to another embodiment of the present invention, an image compression system is provided. The image compression system includes a processing circuit, a compressor and a buffer memory. The post-processing circuit is coupled to the buffer memory and the compressor.

The compressor compresses image data according to a coding algorithm. The post-processing circuit receives image display data of a plurality of image blocks of an image frame in a raster scan order, wherein each of the image blocks includes N rows of pixels, where N is a positive integer greater than 1.

When the post-processing circuit receives the display data of a first image block, and the first image block is an image block located at neither the first row in the image frame nor the last row in the image frame, the post-processing circuit reads data to be processed (to be referred to as intermediate data) of a first buffering image block corresponding to the first image block from the buffer memory, performs post-processing of a coding algorithm on the intermediate data of the first buffering image block and the display data of a first main sub-block in the first image block according to at least the display data of the first image block and the intermediate data of the first buffering image block to generate post-processed data of a first post-processed image block, and stores the intermediate data of a first sub-block to be processed (to be referred to as a first intermediate sub-block) in the first image block that does not belong to the first main sub-block to the buffer memory. The compressor compresses the post-processed data of the first post-processed image block into compression data of the first post-processed image block.

The first intermediate sub-block is the last n rows of pixels in the first image block, and the first main sub-block is the first (N−n) rows of pixels in the first image block, where n is a positive integer smaller than N.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of an image frame to be compressed in the prior art;

FIG. 2 is a schematic diagram of an image compression system according to an embodiment of the present invention;

FIG. 3 is a schematic diagram of image blocks when using the image compression system in FIG. 2 to compress an image frame; and

FIG. 4 and FIG. 5 are flowcharts of a method for compressing an image frame by using an image compression system according to an embodiment of the present invention.

### DETAILED DESCRIPTION OF THE INVENTION

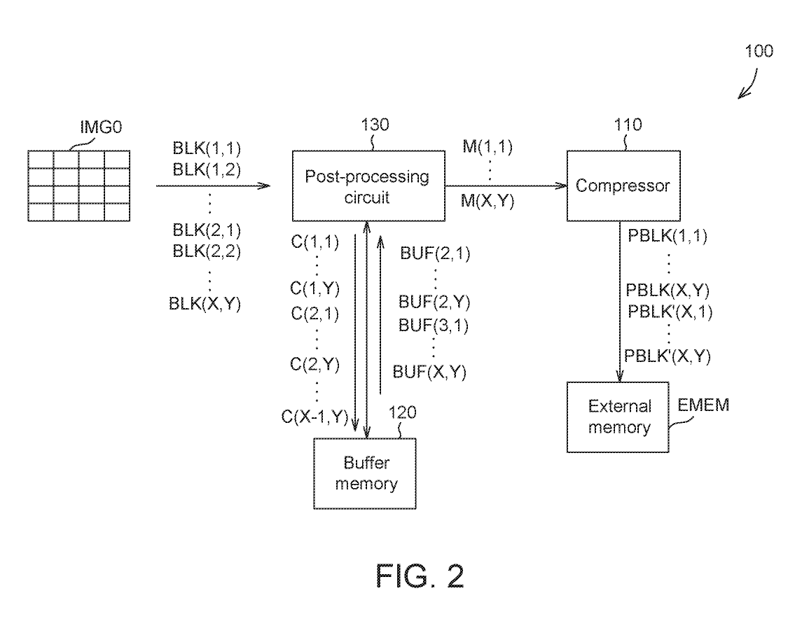

FIG. 2 shows a schematic diagram of an image compression system 100 according to an embodiment of the present invention. The image compression system 100 includes a compressor 110, a buffer memory 120 and a post-processing circuit 130. The post-processing circuit 130 is coupled to the buffer memory 120 and the compressor 110.

The image compression system 100 can first compress an image frame by the compressor 110 before storing the image frame to an external memory EMEM, and then store the compressed image frame to the external memory EMEM, so as to reduce the system needed bandwidth. In some embodiments of the present invention, the compressor 110 selects a known lossless coding algorithm to compress image data.

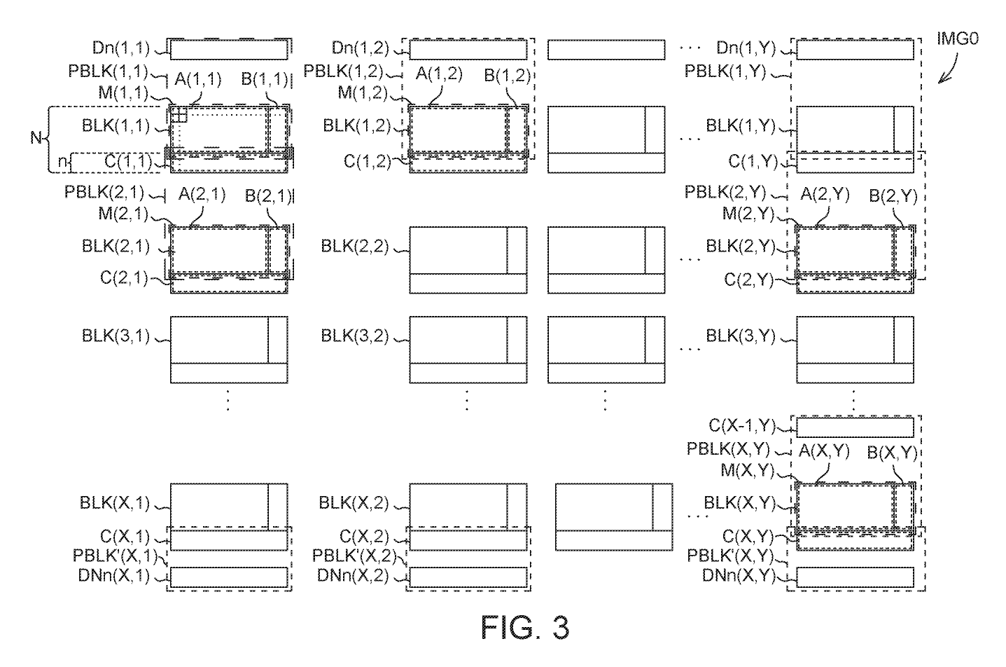

FIG. 3 shows a schematic diagram of image blocks when the image compression system 100 is used for compressing an image frame IMG0. When using the image compression system 100 to perform image compression on the image frame IMG0, the image frame IMG0 is divided into a plurality of image blocks BLK(1, 1) to BLK(X, Y), and the post-processing circuit 130 receives display data of the plurality of image blocks BLK(1, 1) to BLK(X, Y) of the image frame IMG0 in a raster scan order.

Each of the image blocks BLK(1, 1) to BLK(X, Y) includes N rows of pixels, where N is a positive integer greater than 1 and may vary according to different coding algorithms. For example, the video coding standard H.264 defines that each image block includes 16 rows of pixels, i.e., N is equal to 16; HEVC defines that each image block includes 64 rows of pixels, i.e., N is equal to 64. The display data of each of the image blocks BLK(1, 1) to BLK(X, Y) includes the display data of the pixels in each of the image blocks BLK(1, 1) to BLK(X, Y). For example, the display data of the image block BLK(1, 1) can include YCbCr values representing luminance and chrominance of each pixel in the image block BLK(1, 1), or display values according to other types of color spaces.

When post-processing of image compression is performed on each image block, post-processing of image compression on pixels of some sub-blocks can only be completed with reference to display data of other image blocks, whereas post-processing of image compression on pixels of some other sub-blocks can be completed without having to refer to display data of other image blocks. Thus, in some embodiments of the present invention, to reduce the size of the buffer memory 120, the image compression system 100 can store a sub-block that needs display data of other image blocks for performing post-processing to the buffer memory 120 instead of storing the display data of the entire image block to the buffer memory 120. As such, the size of the buffer memory 120 can be significantly reduced.

For example, post-processing can be directly performed on the sub-block A(2, 1) in the image block BLK(2, 1) without having to refer to other image blocks, post-processing of the sub-block B(2, 1) in the image block BLK(2, 1) requires a part of the display data of the image block BLK(2, 2), and post-processing of the sub-block C(2, 1) in the image block (2, 1) requires a part of the display data of the image blocks BLK(3, 1) and BLK(2, 2).

In the above situation, after receiving the image blocks BLK(2, 1) and BLK(2, 2), the post-processing circuit 130 can be prioritized to first perform post-processing on the sub-blocks A(2, 1) and B(2, 1) in the image block BLK(2, 1) and the corresponding sub-blocks in the buffer memory 120, and stores data to be processed (to be referred to as intermediate data) of the sub-block C(2, 1) to be processed (to be referred to as intermediate sub-block) in the image block BLK(2, 1) to the buffer memory 120.

In other words, upon receiving the display data of the images BLK(2, 1) and BLK(2, 2), the post-processing circuit 130 reads the intermediate data of a buffering image block BUF(2, 1) corresponding to the image block BLK(2, 1) from the buffer memory 120, and performs post-processing on the display data of a main sub-block M(2, 1) in the image block BLK(2, 1), i.e., the display data of the sub-blocks A(2, 1) and B(2, 1), and the intermediate data of the buffering image block BUF(2, 1) according to the display data of the image blocks BLK(2, 1) and BLK(2, 2) and the intermediate data of the buffering image block BUF(2, 1), to generate post-processed data of a post-processed image block PBLK(2, 1). Further, the post-processing circuit 130 stores the intermediate data of the intermediate sub-block C(2, 1) in image block BLK(2, 1) that does not belong to the main sub-block M(2, 1) to the buffer memory 120.

In some embodiments of the present invention, the buffer memory 120 may be a static random access memory (SRAM) in the image compression system 100. However, in some other embodiments of the present invention, the buffer memory 120 may also be an external memory outside the image compression system 100. When the buffer memory 120 is outside the image compression system 100, the post-processing circuit 130 can further compress files stored in the buffer memory 120, and decompress and restore the files when reading the files, thus reducing the bandwidth needed for accessing the buffer memory 120.

In some embodiment of the present invention, the intermediate sub-block C(2, 1) is the last n rows of pixels of the image block BLK(2, 1), and the main sub-block M(2, 1) in the image block BLK(2, 1) can include the sub-blocks A(2, 1) and B(2, 1) in the image block BLK(2, 1), i.e., the first (N−n) rows of pixels of the image block BLK(2, 1), where n is a positive integer smaller than N. Further, according to different coding algorithms, the value n may also vary. Therefore, in some embodiments of the present invention, the post-processing circuit 130 can set the value n according to the type of a coding algorithm.

In the above description, the buffering image block BUF(2, 1) corresponding to the image block BLK(2, 1) is located at the same row in the image frame IMG0 as the image block BLK(2, 1), and is located at the intermediate sub-block C(1, 1) in the image block BLK(1, 1) of the previous row of the image block BLK(2, 1). That is to say, the post-processed image block PBLK(2, 1) obtained after the post-processing of the coding algorithm corresponds to the main sub-block M(2, 1) in the image block BLK(2, 1) and the sub-block C(1, 1) in the image block BLK(1, 1), and the compressor 110 can then compress the post-processed data of the post-processed image block PBLK(2, 1) into compression data of the post-processed image block PBLK(2, 1).

In some embodiments of the present invention, because the sub-block C(2, 1) in the image block BLK(2, 1) may need the display data of the image blocks BLK(2, 1) and BLK(2, 2) for post-processing, the post-processing circuit 130 can first perform post-processing of the coding algorithm on the display data of the intermediate sub-block C(2, 1) according to the display data of the image blocks BLK(2, 1) and BLK(2, 2) to generate the intermediate data of the intermediate sub-block C(2, 1). Thus, when the post-processing circuit 130 receives the image block BLK(3, 1), the intermediate data of the buffering image block BUF(3, 1) corresponding to the image block BLK(3, 1) can be read from the buffer memory 120, i.e., the intermediate data of the sub-block C(2, 1) in the image block BLK(2, 1), to complete the post-processing.

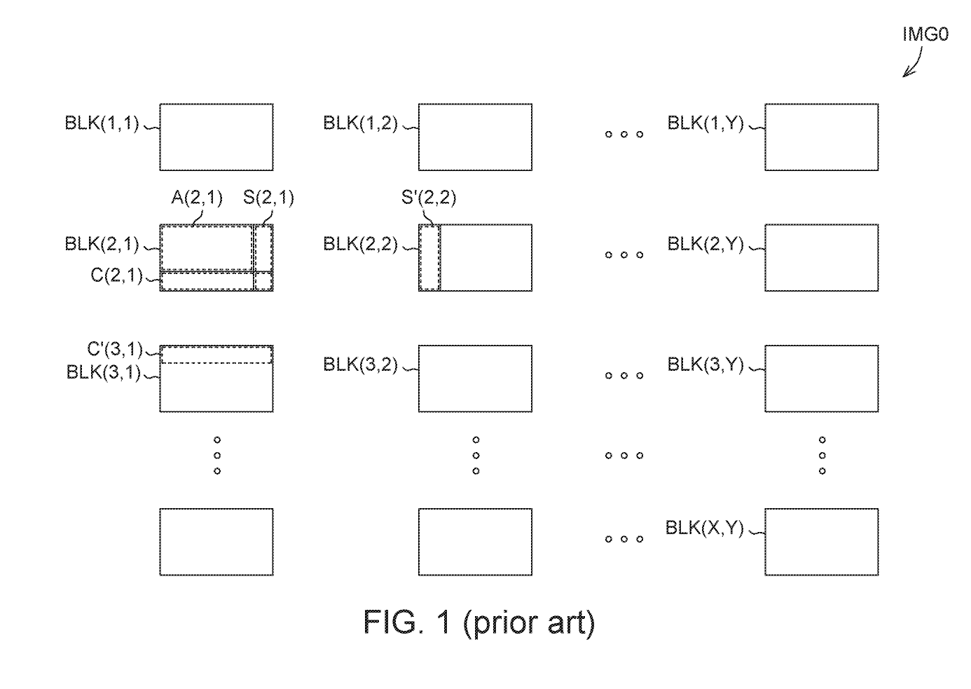

Further, in some embodiments of the present invention, according to different coding algorithms, post-processing of some image blocks in the image frame IMG0 can be completed without having to refer to display data of image blocks on the right of these image blocks. For example, in FIG. 1, the image block BLK(2, Y) is located on the right border of the image frame IMG0, i.e., the image block BLK(2, Y) is the image block located at the last column among all image blocks at the same row. At this point, if post-processing is performed with reference to the display data of the next received image block BLK(3, 1), a corresponding post-processed result may be unsatisfactory because the two image blocks are not spatially connected in the image frame IMG0, and noise may even be induced. In the above situation, upon receiving the image block BLK(2, Y), the post-processing circuit 130 may read the intermediate data of the buffering image block BUF(2, Y) corresponding to the image block BLK(2, Y) from the buffer memory 120, and perform post-processing of a coding algorithm on the intermediate data of the buffering image block BUF(2, Y), i.e., the intermediate data of the sub-block C(1, Y) in the image block BLK(1, Y), and the display data of the main sub-block M(2, Y) in the image block BLK(2, Y), i.e., the display data of the sub-blocks A(2, Y) and B(2, Y), according to the display data of the image block BLK(2, Y) and the intermediate data of the buffering image block BUF(2, Y), to generate post-processed data of a post-processed image block PBLK(2, Y). Further, the post-processing circuit 130 similarly stores the intermediate data of an intermediate sub-block C(2, Y) in the image block BLK(2, Y) that does not belong to the of the main sub-block M(2, Y) to the buffer memory 120.

In the above description, the image blocks BLK(2, 1) and BLK(2, Y) are images located at neither the first row of the image frame IMG0 nor the last row of the image frame IMG0. For the first-row image blocks BLK(1, 1) to BLK(1, Y) in the image frame IMG0, there are no image blocks of a preceding row in the image frame IMG0, i.e., there may be no corresponding buffering image blocks in the buffer memory 120. Thus, post-processing can be directly performed on the main sub-blocks in the first-row image blocks BLK(1, 1) and BLK(1, Y), and store the intermediate sub-blocks that need to refer to other image blocks in the buffer memory 120. However, after post-processing is complete, if post-processed data of the main sub-blocks of these image blocks is compressed, a result that a block size corresponding to the compression data of the first-row image blocks in the image frame IMG0 may differ from a block size corresponding to compression data of non-first-row image blocks in the image frame IMG0 may be incurred, which leads to increased process complexities in subsequent data decompression and restoration.

Similarly, such increased process complexities in a subsequent data decompression and restoration may also occur for the last-row image blocks BLK(X, 1) to BLK(X, Y) in the image frame IMG0.

In some embodiments of the present invention, to prevent the above increased process complexities in subsequent data decompression and restoration caused by different block sizes of different sets of compression data, the post-processing circuit 130 may further construct display data of dummy pixels upon receiving first-row image blocks or last-row image blocks in the image frame IMG0, so as to avoid any complexities in subsequent data decompression and restoration.

For example, when the post-processing circuit 130 receives the display data of the image blocks BLK(1, 1) and BLK(1, 2) located at the first row of the image frame IMG0, the post-processing circuit 130 can perform post-processing of a coding algorithm on the display data of the main sub-block M(1, 1) in the image block BLK(1, 1) according to the display data of the image blocks BLK(1, 1) and BLK(1, 2) to generate post-processed data of the main sub-block M(1, 1), and store the intermediate data of the intermediate sub-block C(1, 1) in the image block BLK(1, 1) that does not belong to the main sub-block M(1, 1) in the memory buffer 120.

The post-processing circuit 130 can further construct display data of n rows of dummy pixels, and the compressor 110 can compress the post-processed data of the main sub-block M(1, 1) and the display data of the n rows of dummy pixels constructed by the post-processing circuit 130 to compression data of a post-processed image block PBLK(1, 1). As such, the block size of the post-processed image block PBLK(1, 1) stays the same as that of a processed image block PBLK(2, 1), and both include N rows of pixels.

In some embodiments of the present invention, to enhance the compression rate, the post-processing circuit 130 can duplicate the display data of the first-row pixels of the image block BLK(1, 1) to construct the display data of the n rows of dummy pixels. That is to say, the display data of n rows of dummy pixels Dn(1, 1) constructed by the post-processing circuit 130 would be the same as the display data of the first-row pixels of the image block BLK(1, 1), which is equivalently increasing the dependency between compression data, thus enhancing the compression rate of the compressor 110.

Further, in other embodiments of the present invention, because the number of the dummy pixels should be a predetermined constant value, the display data of the dummy pixels Dn(1, 1) can be represented by a predetermined value. Thus, when the compressor 110, having identified the value, can directly omit the dummy pixels Dn(1, 1) and leave the dummy pixels Dn(1, 1) uncompressed, thereby further simplifying the compression process as well as reducing the amount of memory used.

Similarly, the main sub-blocks M(1, 2) to M(1, Y) in the other image blocks BLK(1, 2) to BLK(1, Y) located at the first row are also combined with the dummy pixels Dn(1, 2) to Dn(1, Y) constructed by the post-processing circuit 130 into post-processed image blocks PBLK(1, 2) to PBLK(1, Y), which are then compressed by the compressor 110.

Similarly, in another dimension, the similar process can also be performed when the post-processing circuit 130 receives the display data of the last-row image blocks BLK(X, Y) in the image frame IMG0, and such repeated details are omitted herein.

In some embodiments of the present invention, to enhance the compression rate, the post-processing circuit 130 can duplicate the display data of the last-row pixels of the image block BLK(X, Y) to construct the display data of (N−n) rows of dummy pixels Dn(X, Y). That is to say, the display data of the (N−n) rows of dummy pixels Dn(X, Y) constructed by the post-processing circuit 130 is the same as the display data of the last-row pixels of the image block BLK(X, Y), which is equivalently increasing the dependency between compression data, thereby enhancing the compression rate of the compressor 110.

Similarly, the sub-blocks C(X, 1) to C(X, Y−1) in other image blocks BLK(X, 1) to BLK(X, Y−1) located at the last row are also respectively combined with the dummy pixels DNn(X, 1) to DNn(X, Y−1) constructed by the post-processing circuit 130 into post-processed image blocks PBLK′(X, 1) to PBLK′(X, Y−1), which are then compressed by the compressor 110.

Similarly, in other embodiments of the present invention, because the number of the dummy pixels should be a predetermined constant value, the display data of the dummy pixels DNn(X, 1) to DNn(X, Y) can be represented by predetermined values. Thus, when the compressor 110, having identified the values, can directly omit the dummy pixels DNn(X, 1) to DNn(X, Y) and leave the dummy pixels DNn(X, 1) to DNn(X, Y) uncompressed, thereby further simplifying the compression process as well as reducing the amount of memory used.

Because the post-processing circuit 130 in the image compression system 100 can be prioritized to first process the main sub-blocks of the image blocks and store only the intermediate blocks in the image blocks to the buffer memory 120, the capacity required by the buffer memory 120 is reduced.

For example, each image block in the video coding standard H.264 includes 16 rows of pxiels, in which 4 rows require image blocks of a next row to complete post-processing; that is, N is 16 and n is 4. For the prior art, a memory used needs to completely store 16 rows of pixels in each of the image blocks. In comparison, the buffer memory 120 of the image compression system 100 only needs to store 4 rows of pixels of each of the image blocks, hence significantly reducing the capacity of the buffer memory 120. Taking HEVC for example, each image block includes 64 rows of pixels, i.e., N is 64, in which only 4 rows of pixels require image blocks of a next row to complete post-processing, i.e., n is 4. In such situation, the required capacity of the buffer memory 120 of the image compression system 100 is merely approximately 1/16 of the memory capacity previous required, providing an even more remarkable decrease in memory capacity.

In other words, in order to enable each image block to read the corresponding intermediate sub-block located at the previous row, the buffer memory 120 only needs to store data of intermediate blocks of one row of image blocks. Compared to the prior art that requires a buffer memory for storing display data of all image blocks of one entire row, the required capacity of the buffer memory 120 is remarkably reduced, thus avoiding additional hardware resources and at the same time reducing overall system power consumption and bandwidth required as well as the amount of an external memory used. Further, since the post-processing circuit 130 can construct the display data of a corresponding number of dummy pixels after receiving the first-row image blocks or last-row image blocks, the size of the image blocks compressed by the compressor 110 can stay consistent, further preventing additional complexities in subsequent data decompression and restoration.

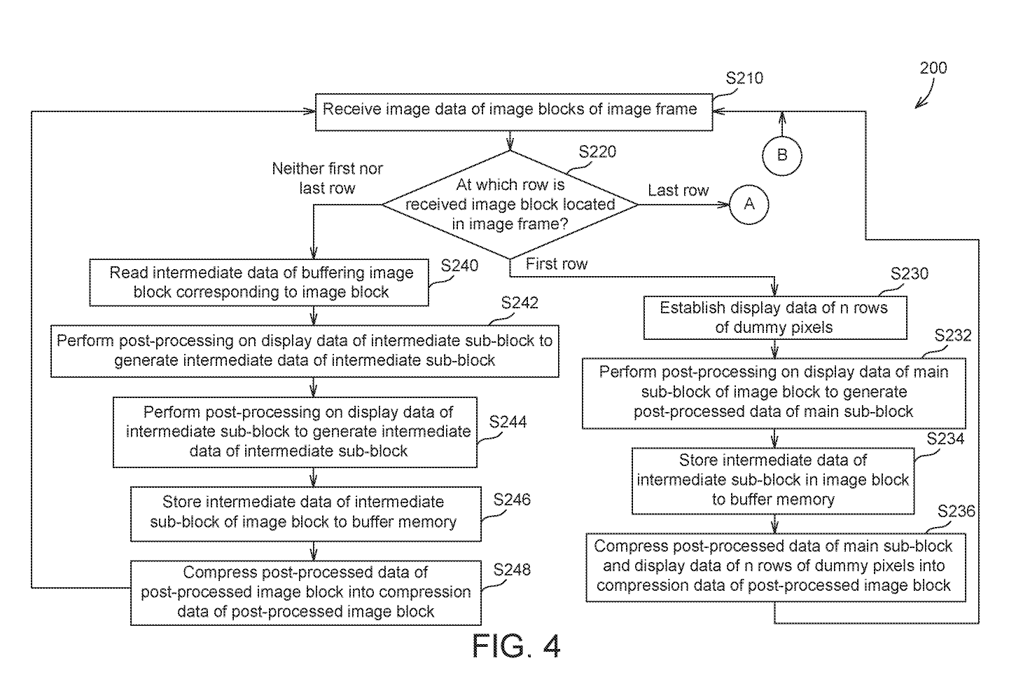

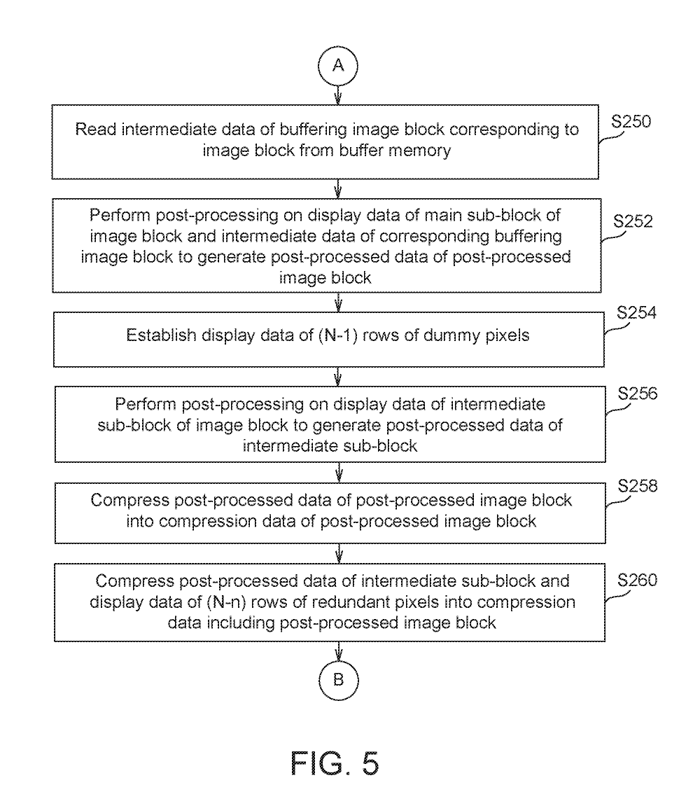

FIG. 4 and FIG. 5 show flowcharts of a method 200 for compressing an image frame IMG0 using an image compression system according to an embodiment of the present invention. The method is applicable to the image compression system 100, and an operation process thereof can include steps S210 to S260 and is not limited to the order shown in FIG. 4 and FIG. 5.

In step S210, the post-processing circuit 130 receives display data of image blocks in the image frame IMG0.

In step S220, if the image block received is located at the first row of the image frame IMG0, step S230 is performed; if the image block received is located at the last row of the image frame IMG0, step S250 is performed; otherwise, step S240 is performed.

In step S230, the post-processing circuit 130 constructs display data of n rows of dummy pixels.

In step S232, the post-processing 130 performs post-processing of a coding algorithm on the display data of a main sub-block in the image block according to the display data of the image block to generate post-processed data of the main sub-block.

In step S234, the post-processing circuit 130 stores intermediate data of an intermediate sub-block in the image block that does not belong to the main sub-block to the buffer memory 120.

In step S236, the compressor 110 compresses the post-processed data of the main sub-block and the display data of the n rows of dummy pixels into compression data of the post-processed image block, followed by performing step S210.

In step S240, the post-processing circuit 130 reads from the buffer memory 120 the intermediate data of a buffering image block corresponding to the image block.

In step S242, the post-processing circuit 130 performs post-processing of a coding algorithm on the display data of the main sub-block in the image block and the intermediate data of the corresponding buffering image block according to the display data of the image block and the intermediate data of the corresponding buffering image block to generate post-processed data of a post-processed image block.

In step S244, the post-processing circuit 130 performs post-processing of a coding algorithm on the display data of the intermediate sub-block according to the display data of the image block to generate the intermediate data of the intermediate sub-block.

In step S246, the post-processing circuit 130 stores the intermediate data of the intermediate sub-block in the image block that does not belong to the main sub-block to the buffer memory 120.

In step S248, the compressor 110 compresses the post-processed data of the post-processed image block into compression data of the post-processed image block, followed by performing step S210.

In step S250, the post-processing circuit 130 reads from the buffer memory 120 intermediate data of a buffering image block corresponding to the image block.

In step S252, the post-processing circuit 110 performs post-processing of a coding algorithm on the display data of the main sub-block in the image block and the intermediate data of the corresponding buffering image block according to the display data of the image block and the intermediate data of the corresponding buffering image block to generate post-processed data of a post-processed image block.

In step S254, the post-processing circuit 130 constructs display data of (N−n) rows of dummy pixels.

In step S256, the post-processing circuit 130 performs post-processing of a coding algorithm on the display data of the intermediate sub-block in the image block that does not belong to the main sub-block according to the display data of the image block to generate post-processed data of the intermediate sub-block.

In step S258, the compressor 110 compresses the post-processed data of the post-processed image block into compression data of the post-processed image block.

In step S260, the compressor 110 compresses the post-processed data of the processed sub-block and the display data of the (N−n) rows of dummy pixels into compression data including the post-processed image block, followed by performing step S210.

The details of the steps in the method 200 are given in the description associated with the operation of the compression system according to foregoing embodiments of the present invention, and are omitted herein.

In conclusion, in the image compression system and the image compression method by using the image compression system according to the embodiments of the present invention, a post-processing circuit can be prioritized to first process a main sub-block in each image block, and only a sub-block to be processed (i.e., an intermediate sub-block) in each image block is stored in a buffer memory. Thus, the required capacity of the buffer memory is reduced, and the overall system power consumption and bandwidth required are also decreased at the same time.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for compressing an image frame by using an image compression system, the image compression system comprising a post-processing circuit, a compressor and a buffer memory, the method comprising:
transmitting display data of a plurality of image blocks in the image frame in a raster scan order to the post-processing circuit, wherein each of the image blocks comprises N rows of pixels and N is a positive integer greater than 1;
when the post-processing circuit receives the display data of a first image block and the first image block is an image block located at neither a first row in the image frame nor a last row in the image frame:
the post-processing circuit reading intermediate data of a first buffering image block corresponding to the first image block from the buffer memory;
the post-processing circuit performing post-processing of a coding algorithm on the intermediate data of the first buffering image block and the display data of a first main sub-block in the first image block according to at least the display data of the first image block and the intermediate data of the first buffering image block to generate post-processed data of a first post-processed image block; and
the post-processing circuit storing intermediate data of a first intermediate sub-block in the first image block in the buffer memory, wherein the first intermediate sub-block is a part in the first image block that does not belong to the first main sub-block; and
the compressor compressing the post-processed data of the first post-processed image block into compression data of the first post-processed image block;
wherein, the first intermediate sub-block is last n rows of pixels in the first image block, the first main sub-block is first (N−n) rows of pixels in the first image block, and n is a positive integer smaller than N.

2. The method according to claim 1, wherein the first buffering image block corresponding to the first image block is located at the same row in the image frame as the first image block, and is located at an intermediate sub-block of an image block of a previous row of the first image block.

3. The method according to claim 1, wherein the step of the post-processing circuit performing the post-processing of the coding algorithm on the intermediate data of the first buffering image block and the display data of the first main sub-block in the first image block according to at least the display data of the first image block and the intermediate data of the first buffering image block to generate the post-processed data of the first post-processed image block is:
after the post-processing circuit receives the first image block and when the post-processing circuit sequentially receives a second image block located at the same row as the first image block, the post processing circuit performing the post-processing of the coding algorithm on the intermediate data of the first buffering image block and the display data of the first main sub-block in the first image block according to the display data of the first image block and the second image block to generate the post-processed data of the first post-processed image block.

4. The method according to claim 1, further comprising:
when the post-processing circuit receives the display data of the first image block, the post-processing circuit performing the post-processing of the coding algorithm on the display data of the intermediate sub-block according to at least the display data of the first image block to generate the intermediate data of the first intermediate sub-block.

5. The method according to claim 1, further comprising:
when the post-processing circuit receives the display data of a third image block located at the first row of the image block:
the post-processing circuit constructing display data of n rows of dummy pixels;
the post-processing circuit performing the post-processing of the coding algorithm on the display data of a third main sub-block in the third image block according to at least the display data of the third image block to generate post-processed data of the third main sub-block; and
the post-processing circuit storing intermediate data of a third intermediate sub-block in the third image block that does not belong to the third main sub-block to the memory buffer; and
the compressor compressing the post-processed data of the third main sub-block and the display data of the n rows of dummy pixels into compression data of a third post-processed image block.

6. The method according to claim 5, wherein the step of the post-processing circuit constructing the display data of the n rows of dummy pixels is the post-processing circuit constructing the display data of the n rows of dummy pixels by duplicating the display data of pixels of a first row of the third image block.

7. The method according to claim 1, further comprising:
when the post-processing circuit receives the display data of a fourth image block located at a last row of the image frame:
the post-processing circuit reading intermediate data of a fourth buffering image block corresponding to the fourth image block from the buffer memory;
the post-processing circuit performing the post-processing of the coding algorithm on the intermediate data of the fourth buffering image block and the display data of a fourth main sub-block in the fourth image block according to at least the display data of the fourth image block and the intermediate data of the fourth buffering image block to generate post-processed data of a fourth post-processed image block;
the post-processing circuit constructing display data of (N−n) rows of dummy pixels; and
the post-processing circuit performing the post-processing of the coding algorithm on the display data of a fourth intermediate sub-block in the fourth image block that does not belong to the fourth main sub-block according to at least the display data of the fourth image block to generate post-processed data of the fourth intermediate sub-block;
the compressor compressing the post-processed data of the fourth post-processed image block into compression data of the fourth post-processed image block; and
the compressor compressing the post-processed data of the fourth intermediate sub-block and the display data of the (N−n) rows of dummy pixels into compression data including the post-processed image block.

8. The method according to claim 7, wherein the step of the post-processing circuit constructing the display data of the (N−n) rows of dummy pixels is constructing the display data of the (N−n) rows of dummy pixels by duplicating the display data of pixels of a last row of the fourth image block.

9. An image compression system, comprising:
a compressor, compressing image data according to a coding algorithm;
a buffer memory; and
a post-processing circuit, coupled to the buffer memory and the compressor, the post-processing circuit:
receiving display data of a plurality of image blocks in the image frame in a raster scan order, wherein each of the image blocks comprises N rows of pixels and N is a positive integer greater than 1;
when receiving the display data of a first image block, the first image block being an image block located at neither a first row in the image frame nor a last row in the image frame:
reading intermediate data of a first buffering image block corresponding to the first image block from the buffer memory;
performing post-processing of the coding algorithm on the intermediate data of the first buffering image block and the display data of a first main sub-block in the first image block according to at least the display data of the first image block and the intermediate data of the first buffering image block to generate post-processed data of a first post-processed image block; and
storing intermediate data of a first intermediate sub-block in the first image block that does not belong to the first main sub-block to the buffer memory;
wherein, the compressor further compresses the post-processed data of the first post-processed image block into compression data of the first post-processed image block; the first intermediate sub-block is last n rows of pixels in the first image block, the first main sub-block is first (N−n) rows of pixels in the first image block, and n is a positive integer smaller than N.

10. The system according to claim 9, wherein the first buffering image block corresponding to the first image block is located at the same row in the image frame as the first image block, and is located at an intermediate sub-block of an image block of a previous row of the first image block.

11. The system according to claim 9, wherein the post-processing circuit performing the post-processing of the coding algorithm on the intermediate data of the first buffering image block and the display data of the first main sub-block in the first image block according to at least the display data of the first image block and the intermediate data of the first buffering image block to generate the post-processed data of the first post-processed image block is:
after the post-processing circuit receives the first image block and when the post-processing circuit sequentially receives a second image block located at the same row as the first image block, the post processing circuit performing the post-processing of the coding algorithm on the intermediate data of the first buffering image block and the display data of the first main sub-block in the first image block according to the display data of the first image block and the second image block to generate the post-processed data of the first post-processed image block.

12. The system according to claim 9, wherein when the post-processing circuit receives the display data of the first image block, the post-processing circuit performs the post-processing of the coding algorithm on the display data of the intermediate sub-block according to at least the display data of the first image block to generate the intermediate data of the first intermediate sub-block.

13. The system according to claim 9, wherein when the post-processing circuit receives the display data of a third image block located at the first row of the image block, the post-processing circuit further:
constructs display data of n rows of dummy pixels;
performs the post-processing of the coding algorithm on the display data of a third main sub-block in the third image block according to at least the display data of the third image block to generate post-processed data of the third main sub-block; and
stores intermediate data of a third intermediate sub-block in the third image block that does not belong to the third main sub-block to the memory buffer; and
wherein, the compressor compresses the post-processed data of the third main sub-block and the display data of the n rows of dummy pixels into compression data of a third post-processed image block.

14. The system according to claim 13, wherein the post-processing circuit constructs the display data of the n rows of dummy pixels by duplicating the display data of pixels of a first row of the third image block.

15. The system according to claim 15, wherein when the post-processing circuit receives the display data of a fourth image block located at a last row of the image frame, the post-processing circuit further:
reads intermediate data of a fourth buffering image block corresponding to the fourth image block from the buffer memory;
performs the post-processing of the coding algorithm on the intermediate data of the fourth buffering image block and the display data of a fourth main sub-block in the fourth image block according to at least the display data of the fourth image block and the intermediate data of the fourth buffering image block to generate post-processed data of a fourth post-processed image block;
constructs display data of (N−n) rows of dummy pixels; and
performs the post-processing of the coding algorithm on the display data of a fourth intermediate sub-block in the fourth image block that does not belong to the fourth main sub-block according to at least the display data of the fourth image block to generate post-processed data of the fourth intermediate sub-block; and
wherein, the compressor further compresses the post-processed data of the fourth post-processed image block into compression data of the fourth post-processed image block, and compresses the post-processed data of the fourth intermediate sub-block and the display data of the (N−n) rows of dummy pixels into compression data including the post-processed image block.

16. The system according to claim 15, wherein the post-processing circuit constructs the display data of pixels of a last row of the fourth image block by duplicating the display data of pixels of a last row of the fourth image block.
